(19) United States
(12) Patent Application Publication
(10) Pub. No.: US 2017/0211645 A1
(43) Pub. Date: Jul. 27, 2017

(54) PNEUMATIC DISC BRAKE PRESSURE ARM HAVING BEARING LIMITING STRUCTURE

(71) Applicant: WUHAN YOUFIN AUTOPARTS CO., LTD., Wuhan (CN)

(72) Inventors: Zhen CHEN, Wuhan (CN); Song SU, Wuhan (CN); Chao SHI, Wuhan (CN); Xiong YANG, Wuhan (CN)

(73) Assignee: WUHAN YOUFIN AUTOPARTS CO., LTD., Wuhan (CN)

(21) Appl. No.: 15/328,902

(22) PCT Filed: Jul. 22, 2015
(86) PCT No.: PCT/CN2015/084784

§ 371 Date: Jan. 24, 2017

(30) Foreign Application Priority Data
Jul. 25, 2014 (CN) 201410358047.5

(51) Int. Cl. F16D 65/18; F16D 65/095

(52) U.S. Cl. CPC F16D 65/18; F16D 65/095; F16D 2121/02

(57) ABSTRACT

Disclosed is a pneumatic disc brake pressure arm having a bearing limiting structure. One end of a pressure arm is a force-bearing part and the other end is a force-exerting part. An inner surface of the force-exerting part is a rotation arc face and an outer surface is a propulsion arc face. A fulcrum cylindrical post is arranged in a recess and is arranged concentrically with the rotation arc face, multiple needle bearings are provided around the fulcrum cylindrical post, a positioning block is arranged on one side of the fulcrum cylindrical post. A force-exerting part is provided with a limiting block and a limiting plate at the rotation arc face, and a lower end face of the limiting block is higher than the inner surface of the positioning block and lower than a top part of the needle bearings.

### CROSS REFERENCE TO RELATED APPLICATIONS

This application is the national phase entry of International Application No. PCT/CN2015/084784, filed on Jul. 22, 2015, which is based upon and claims priority to Chinese Patent Application No. 201410358047.5. filed on Jul. 25, 2014, the entire contents of which are incorporated herein by reference.

### TECHNICAL FIELD

The present invention relates to a pneumatic disc brake pressure arm, and in particular to a pneumatic disc brake pressure arm having a bearing limiting structure.

### BACKGROUND OF THE PRESENT INVENTION

At present, disc brakes have advantages incomparable to drum brakes, and pneumatic disc brakes have also been applied more and more widely in the field of commercial vehicles. Pneumatic disc brakes realize braking by providing a stable and effective braking torque and hindering the rotation of wheels by means of the torque generated by the contact of a friction plate with a brake disc. As the most key component of a force increasing mechanism, a pressure arm amplifies the input force input by a cylinder by multiples by the lever principle, so as to provide a sufficient braking torque.

The pressure arm is fixed on a caliper body through needle bearings, a pivot cylinder and a positioning block. When the pressure arm is actuated by the cylinder, a rotary circular arc surface rotates about an axis center, and a sliding bearing or needle bearing with a low friction coefficient rolls around a fixed point on the pressure arm. When the circular arc center of a thrust surface of the pressure arm is at a maximum stroke position, the center will generate a displacement simultaneously in the leftward direction (generate a braking force) and the up-and-down direction. When the pressure arm is rotated from position 1 to position 2, the position of the center of the rotary circular arc remains unchanged, while the position of the circular arc center of the thrust surface is changed. The horizontal component (3.8 mm in FIG. 1) of the displacement represents the direction of moving a reference base to generate a thrust to the friction plate, and the vertical component (0.31 mm in FIG. 1) of the displacement represents that the needle thrust bearing moves towards the direction parallel to the brake disc. Meanwhile, the sliding bearing or needle bearing with a low friction coefficient rolls by a certain distance in a small circular arc of the pressure arm. Since the circular arc movement speed of the sliding bearing or needle bearing is slower than the circular arc movement speed of the pressure arm, after multiple times of brakings, the sliding bearing or needle bearing has a movement trend of rolling out of the small circular arc of the pressure aim (as shown in FIGS. 2 and 3). If the sliding bearing or needle bearing rolls out of the small circular arc of the pressure arm, the pivot cylinder will directly come into contact with the small circular arc of the pressure arm, and consequently, the braking system will be locked and the whole braking system is disabled. How to reduce or eliminate the occurrence of the sliding bearing or needle bearing rolling out of the small circular arc of the pressure arm is the current design goal.

Therefore, it is necessary to design a pneumatic disc brake pressure arm having a bearing limiting structure in order to overcome the problem described above.

### SUMMARY OF INVENTION

An objective of the present invention is to overcome the defects of the prior art and provide a pneumatic disc brake pressure arm having a bearing limiting structure which prevents needle bearings from rolling out during movement.

For this purpose, the technical solutions of the present invention are realized as follows: a pneumatic disc brake pressure arm having a bearing limiting structure is provided, comprising a pressure arm, wherein the pressure arm is fixed on a caliper body of a pneumatic disc brake through needle bearings, a pivot cylinder and a positioning block;

one end of the pressure arm is a stressed portion and the other end thereof is a spinning portion, with an inner surface of the spinning portion being a rotary circular arc surface and an outer surface thereof being a thrust circular arc surface; the pivot cylinder is provided inside a concave portion formed by the rotary circular arc surface, and the pivot cylinder and the rotary circular arc surface are arranged concentrically; a plurality of the needle bearings are arranged around the pivot cylinder, and located between the rotary circular arc surface and the pivot cylinder; and, the positioning block is arranged on one side of the pivot cylinder away from the rotary circular arc surface; and

the spinning portion is provided with a limiting block at an upper end of the rotary circular arc surface, and provided with a limiting sheet at a lower end of the rotary circular arc surface, wherein a lower end face of the limiting block is above the inner surface of the positioning block and below the top of the needle bearing closest to the limiting block.

Further, the thrust circular arc surface and the pivot cylinder are not arranged concentrically.

Further, the limiting block and the spinning portion are formed integrally.

Further, the limiting block is mounted and fixed at the upper end of the rotary circular arc surface.

Further, the limiting sheet is fixed at the lower end of the rotary circular arc surface via a rivet in order to resist against the needle bearing closest to the limiting sheet.

Further, a slot is provided on an outer side of a lower end portion of the spinning portion; a through hole communicating the rotary circular arc surface with the outer side of the lower end portion of the spinning portion is provided inside the slot; and, the rivet is provided inside the through hole.

Further, the limiting sheet is bent and extended from the outer side of the lower end portion of the spinning portion to cover the lower end portion of the spinning portion, and then bent and extended inwardly to the lower end of the rotary circular arc surface.

Further, the spinning portion is formed by bending and extending the stressed portion downwardly, and the spinning portion is of an arc structure.

The present invention has the following advantageous effects:

The spinning portion is provided with a limiting block at an upper end of the rotary circular arc surface, and provided with a limiting sheet at a lower end of the rotary circular arc surface; and, a lower end face of the limiting block is above the inner surface of the positioning block and below the top of the needle bearing closest to the limiting block. When the needle bearing moves to the limiting block, in the continuous backward movement process of the needle bearing, the limiting block draws back the needle bearing so as to prevent the needle bearing from rolling out of the rotary circular arc surface of the pressure aim; and when the needle bearing moves to the limiting sheet, in the continuous forward movement of the needle bearing, the limiting sheet draws back the needle bearing so as to prevent the needle bearing from rolling out of the rotary circular arc surface of the pressure aim. Thus, the normal operation of the pneumatic disc brake pressure aim having a bearing limiting structure is ensured.

### BRIEF DESCRIPTION OF THE DRAWINGS

FIG. 1 is a structural diagram of a conventional pressure arm;

FIG. 2 is a movement trend chart of a needle bearing of the conventional pressure arm;

FIG. 3 is another movement trend chart of the needle bearing of the conventional pressure arm;

FIG. 4 is a structural diagram of a pneumatic disc brake pressure arm having a bearing limiting structure according to an embodiment of the present invention; and

FIG. 5 is a stereoscopic diagram of the pressure arm according to an embodiment of the present invention.

### DETAILED DESCRIPTION OF THE INVENTION

The technical solutions in the embodiments of the present invention will be clearly and completely described below with reference to the accompanying drawings in the embodiments of the present invention. Apparently the embodiments described herein are merely a part but not all of the embodiments of the present invention. All of the other embodiments obtained based on the embodiments in the present invention by one person of ordinary skill in the art without any creative effort shall fall into the protection scope of the present invention.

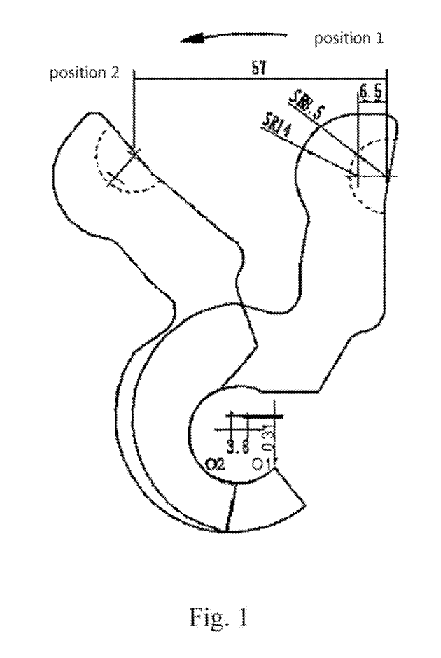

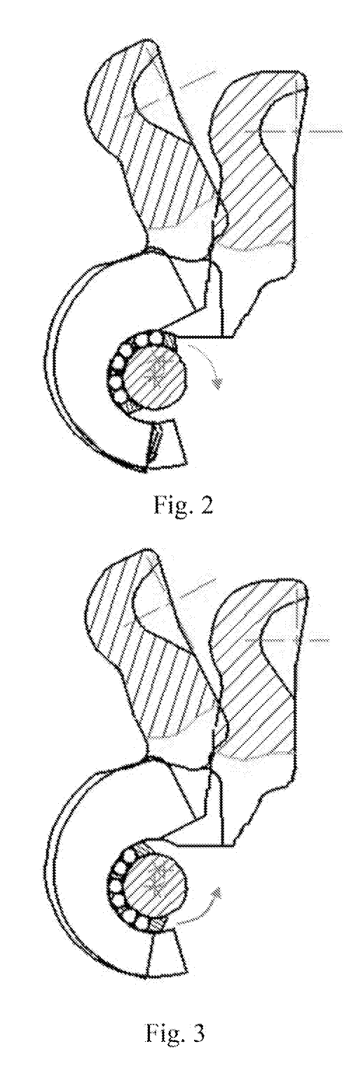

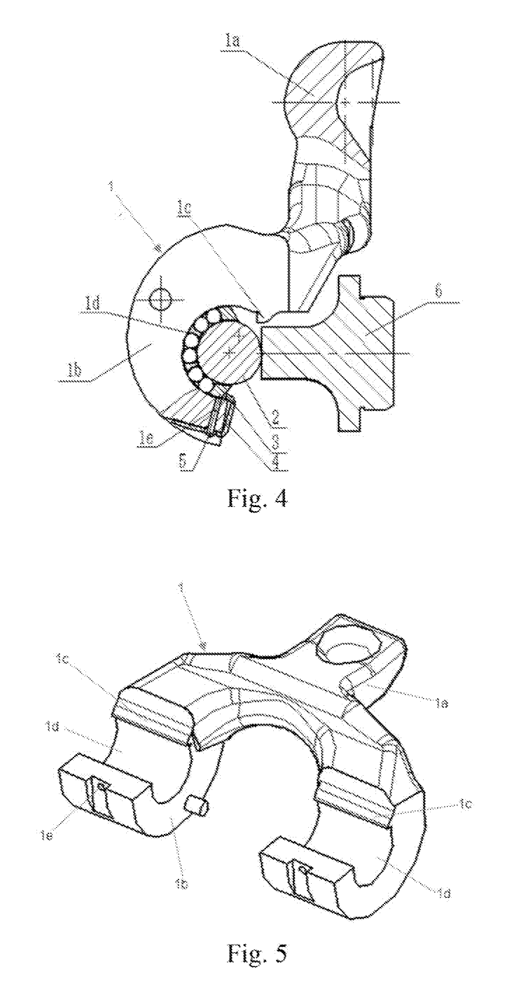

As shown in FIGS. 1 to 5, an embodiment of the present invention provides a pneumatic disc brake pressure arm having a bearing limiting structure, comprising a pressure arm 1. The pressure arm 1 is fixed on a caliper body of a pneumatic disc brake through needle bearings 3, a pivot cylinder 2 and a positioning block 6.

As shown in FIGS. 1 to 5, one end of the pressure arm 1 is a stressed portion la and the other end thereof is a spinning portion 1b. The spinning portion 1b is formed by bending and extending the stressed portion 1a downwardly, and the spinning portion 1b is of an arc structure. An inner surface of the spinning portion 1b is a rotary circular arc surface 1d, and an outer surface thereof is a thrust circular arc surface. The pivot cylinder 2 is provided inside a concave portion formed by the rotary circular arc surface 1d, and the pivot cylinder 2 and the rotary circular arc surface 1d are arranged concentrically. The thrust circular arc surface and the pivot cylinder 2 are not arranged concentrically, so that the thrust circular arc surface and the rotary circular arc surface 1d have different rotation angles.

As shown in FIGS. 1 to 5, a plurality of the needle bearings 3 are arranged around the pivot cylinder 2, and located between the rotary circular arc surface 1d and the pivot cylinder 2; and, the positioning block 6 is arranged on one side of the pivot cylinder 2 away from the rotary circular arc surface 1d, and the positioning block 6 is used for resisting against the pivot cylinder 2.

As shown in FIGS. 1 to 5, the spinning portion 1b is provided with a limiting block 1c at the upper end of the rotary circular arc surface 1d. In this preferred embodiment, the limiting block is and the spinning portion 1b are formed integrally. That is, the limiting block 1c is protruded from the spinning portion 1b. In other embodiments, the limiting block 1c is mounted and fixed at the upper end of the rotary circular arc surface 1d. That is, the limiting block 1c is formed separately, and then mounted at the upper end of the rotary circular arc surface 1d of the spinning portion 1b. In that, a lower end face of the limiting block 1c is above the inner surface of the positioning block 6 and below the top of the needle bearing 3 closest to the limiting block 1c. Making the lower end face of the limiting block 1c above the inner surface of the positioning block 6 avoids the interference generated between the limiting block 1c and the positioning block 6, which influences the normal operation of the separate pressure arm 1. Making the lower end face of the limiting block 1c below the top of the needle bearing 3 closest to the limiting block 1c is for the purpose of resisting against the needle bearing 3. If the lower end face of the limiting block 1c is above the top of the needle bearing 3 closest to the limiting block 1c, the positioning block 6 is unable to limit the needle bearing 3, and the needle bearing 3 is likely to roll out.

As shown in FIGS. 1 to 5, the spinning portion 1b is provided with a limiting sheet 4 at the lower end of the rotary circular arc surface 1d. The limiting sheet 4 is fixed at the lower end of the rotary circular arc surface 1d via a rivet in order to resist against the needle bearing 3 closest to the limiting sheet 4 so as to prevent the needle bearing 3 from rolling out. In this preferred embodiment, a slot (shown, but not numbered) is provided on an outer side of a lower end portion of the spinning portion 1b; a through hole 1e communicating the rotary circular arc surface 1d with the outer side of the lower end portion of the spinning portion 1b is provided inside the slot; and, the rivet is provided inside the through hole 1e. The limiting sheet 4 is fixed by the rivet. The limiting sheet 4 is bent and extended from the outer side of the lower end portion of the spinning portion 1b to cover the lower end portion of the spinning portion 1b. and then bent and extended inwardly to the lower end of the rotary circular arc surface 1d, so as to resist against the lowermost needle bearing 3.

As shown in FIGS. 1 to 5, the stressed portion 1a of the pressure arm 1 is actuated by a cylinder; the spinning portion 1b rotates about the center of the pivot cylinder 2, and, in the process of the circular arc center of the thrust surface of the pressure arm 1 moving to a maximum stroke position, the needle bearings 3 roll inside the rotary circular arc surface 1d of the pressure arm 1. Within the small circular arc range formed by the rotary circular arc surface 1d of the pressure arm 1, the linear speed of the needle bearing 3 in contact with the rotary circular arc surface 1d is the same as that of the rotary circular arc surface 1d. Since the pitch diameter of the needle bearing 3 is smaller than that of the rotary circular arc surface 1d, the angular speed of the needle bearing 3 is smaller than that of the rotary circular arc surface 1d. In other words, the needle bearing 3 rolls slowly relative to the small circular arc formed by the rotary circular arc surface id of the pressure arm 1. After a certain number of brakings, the needle bearing 3 has a trend of rolling out of the small circular arc of the pressure arm 1.

As shown in FIGS. 1 to 5, the spinning portion 1b is provided with a limiting block is at the upper end of the rotary circular arc surface 1d, and a limiting sheet 4 is provided at the lower end of the rotary circular arc surface 1d; and, a lower end face of the limiting block 1c is above the inner surface of the positioning block 6 and below the top of the needle bearing 3 closest to the limiting block 1c. When the needle bearing 3 moves to the limiting block 1c, in the continuous backward movement process of the needle bearing 3, the limiting block 1c draws back the needle bearing 3 so as to prevent the needle bearing 3 from rolling out of the rotary circular arc surface 1d of the pressure arm 1; and when the needle bearing 3 moves to the limiting sheet 4, in the continuous forward movement of the needle bearing 3, the limiting sheet 4 draws back the needle bearing 3 so as to prevent the needle bearing 3 from rolling out of the rotary circular arc surface 1d of the pressure arm 1. Thus, the normal operation of the pneumatic disc brake pressure arm 1 having a bearing limiting structure is ensured.

Under the cooperative action of the limiting block 1c and the limiting sheet 4, the pneumatic disc brake pressure arm having a bearing limiting structure ensures that the needle bearings 3 are always within the range of the rotary circular arc surface id of the pressure arm 1 in any case during braking, so that the braking device provides a stable and effective braking torque and the driving safety is ensured.

The forgoing description merely shows preferred embodiments of the present invention and is not intended to limit the present invention. Any modification, equivalent replacement or improvement made within the spirit and principle of the present invention shall fall into the protection scope of the present invention.

1. A pneumatic disc brake pressure arm having a bearing limiting structure, comprising a pressure arm, wherein the pressure arm is fixed on a caliper body of a pneumatic disc brake through a plurality of needle bearings, a pivot cylinder and a positioning block;
wherein a one end of the pressure arm is a stressed portion and an other end thereof is a spinning portion, with an inner surface of the spinning portion being a rotary circular arc surface and an outer surface thereof being a thrust circular arc surface; the pivot cylinder is provided inside a concave portion formed by the rotary circular arc surface, and the pivot cylinder and the rotary circular arc surface are arranged concentrically; a plurality of the needle bearings are arranged around the pivot cylinder, and located between the rotary circular arc surface and the pivot cylinder; and, the positioning block is arranged on one side of the pivot cylinder away from the rotary circular arc surface; and
wherein the spinning portion is provided with a limiting block at an upper end of the rotary circular arc surface, and provided with a limiting sheet at a lower end of the rotary circular arc surface, wherein a lower end face of the limiting block is above the inner surface of the positioning, block and below the top of the needle bearing closest to the limiting block, the limiting block and the spinning portion are formed integrally, and, the positioning block is contacted with the arc surface of the pivot cylinder.

2. The pneumatic disc brake pressure arm having a bearing limiting structure according to claim 1, wherein the thrust circular arc surface and the pivot cylinder are not arranged concentrically.

3. (canceled)

4. The pneumatic disc brake pressure arm having a bearing limiting structure according to claim 1, wherein the limiting block is mounted and fixed at the upper end of the rotary circular arc surface.

5. The pneumatic disc brake pressure arm having a bearing limiting structure according to claim 1, wherein the limiting sheet is fixed at the lower end of the rotary circular arc surface via a rivet in order to resist against the needle bearing closest to the limiting sheet.

6. The pneumatic disc brake pressure arm having a bearing limiting structure according to claim 5, wherein a slot is provided on an outer side of a lower end portion of the spinning portion; a through hole communicating the rotary circular arc surface with the outer side of the lower end portion of the spinning portion is provided inside the slot; and, the rivet is provided inside the through hole.

7. The pneumatic disc brake pressure arm having a bearing limiting structure according to claim 1, wherein the limiting sheet is bent and extended from the outer side of the lower end portion of the spinning portion to cover the lower end portion of the spinning portion, and then bent and extended inwardly to the lower end of the rotary circular arc surface.

8. The pneumatic disc brake pressure arm having a bearing limiting structure according to claim 1, wherein the spinning portion is formed by bending and extending the stressed portion downwardly, and the spinning portion is of an arc structure.
